(19) United States
(12) Patent Application Publication
(10) Pub. No.: US 2025/0110237 A1
(43) Pub. Date: Apr. 3, 2025

(54) METHOD FOR OPERATING A SCANNING ACOUSTIC MICROSCOPE

(71) Applicant: PVA TEPLA ANALYTICAL SYSTEMS GMBH, Westhausen (DE)

(72) Inventors: Peter HOFFROGGE, Oberkochen (DE); Ingo WIESLER, Gaildorf (DE); Stefan KOENIG, Eisenberg (DE); Mario WOLF, Nossen (DE)

(73) Assignee: PVA TEPLA ANALYTICAL SYSTEMS GMBH, Westhausen (DE)

(21) Appl. No.: 18/980,684

(22) Filed: Dec. 13, 2024

Related U.S. Application Data
(63) Continuation of application No. PCT/EP2023/076778, filed on Sep. 27, 2023.

(30) Foreign Application Priority Data
Oct. 4, 2022 (DE) 10 2022 125 493.3

(51) Int. Cl. G01S 15/89; G01S 7/52

(52) U.S. Cl. CPC G01S 15/8938; G01S 7/5202; G01S 7/52079

(57) ABSTRACT

A method for operating a scanning acoustic microscope. The method including: scanning a sample in an X-Y plane by a transducer unit having one or more transducers. Wherein the scanning includes: moving the transducer unit in the X direction for a linear scanning of the sample; after the linear scanning of the sample by the transducer unit, displacing the transducer unit in the Y direction by a displacement increment; and varying a size of the displacement increment of the transducer unit in the Y direction for the scanning of the sample.

### CROSS-REFERENCE TO RELATED APPLICATION

The present application is a continuation of PCT/EP2023/076778 filed on Sep. 27, 2023, which claims priority to German Patent Application No. DE 10 2022 125 493.3, filed on Oct. 4, 2022, the entire contents of each of which are incorporated herein by reference.

### BACKGROUND

### Field

The present disclosure relates to a method for operating a scanning acoustic microscope, for example an ultrasonic scanning microscope, and a scanning acoustic microscope, for example an ultrasonic scanning microscope.

### Prior Art

Acoustic microscopes, such as ultrasonic microscopes, which are also referred to as scanning acoustic microscopes (SAMs), are employed in order to scan samples by means of ultrasound in a scanning method and to process the reflected sound waves in order to generate images of structures of the sample therefrom.

Hereby, the ultrasonic microscopes possess an ultrasonic head, which is also referred to as a transducer head. Therefore, the ultrasonic head consists of an acoustic lens and a sound converter (transducer) connected thereto.

In the case of examination in the acoustic microscopy, water is used as the coupling medium between the acoustic transducer and the sample to be examined in order to obtain a good transmission of the sound waves emitted by the transducer to the sample. For this purpose, a coupling medium with good properties for sound conduction is required.

In ultrasonic microscopy, which operates in the frequency range of 1 MHz to 5 GHz, it is typical for the samples to be submerged in a water basin and to be placed on a sample holder, the examination of the sample being conducted in immersion by means of an ultrasonic microscope. In another method, a water jet is used that is formed between the sound converter and the sample in order to ensure a good sound coupling into the sample.

Ultrasonic microscopes, in which a sample is scanned by means of ultrasound and the sound waves passed through or reflected are processed in order to generate an image therefrom, are known from the prior art. The imaging is non-destructive, wherein thereby information about the internal structure of a sample is obtained. Via the images gained in the scanning method analyses or monitoring of materials, electronic components, etc. are possible.

Further, in the acoustic microscopy, multichannel transducers are used, in which a great many individual elements with a fixed focal length are arranged next to each other. The pixel size in the Y direction, i.e. perpendicular to the scanning direction in the X direction, thereby corresponds to the distance of the individual transducer elements to each other. In the case of using such multichannel transducers many parallel linear scanning lines are recorded simultaneously corresponding to the number of transducer elements. In the case of transducer elements of the multi-channel transducers, the distance of the individual elements to each other is constant and not changeable, whereby the height of a line of a linear scan is fixed and the pixel size in the Y direction, i.e. perpendicular to the scanning direction in the X direction, always corresponds to the width of the individual transducer elements and is constant. Due to the small dimension of the individual elements in the Y direction, i.e. perpendicular to the scanning direction in the X direction, the aperture of the lenses of the transducer elements in this direction is very small, whereby the resolution in the Y direction is small.

### SUMMARY

An object is to increase application possibilities in acoustic microscopy, for examining samples, such as wafers, etc. A further object is to examine large-volume, such as large-area samples, for example, with a high data throughput, in an efficient and simple manner by an acoustic microscope, for example, an ultrasonic scanning microscope.

Such object can be solved by a method for operating a scanning acoustic microscope, for example, an ultrasonic scanning microscope, wherein a sample is scanned in an X-Y plane by a transducer unit, for example, with one or more transducer elements comprising one transducer and one lens, wherein the transducer unit is moved in the X direction for a linear scanning of the sample, wherein, after a linear scanning of the sample by the transducer unit, the transducer unit is displaced in the Y direction by a displacement increment, wherein the size of the displacement increment of the transducer unit in the Y direction is varied for the scanning of the sample, wherein, after the displacement of the transducer unit in the Y direction, at least one further linear scanning of the sample can be performed by the transducer unit in the Y direction.

In the method, during an examination of a sample by the scanning method, the displacement increment of the transducer unit in the Y direction can be changed during the performance of the scanning method, whereby it is possible to scan, such as to examine, particular regions of a sample with a higher (pixel) resolution and other less interesting regions of the sample with a lower (pixel) resolution. Thereby, the time for an entire examination of the sample can be shortened.

The scanning method can allow for the use of transducer units with several transducer elements, wherein the lateral dimension of the transducer elements can be larger than a pixel size, wherein restrictions in the free choice of the pixel size and losses in the resolution capacity and in the detection sensitivity can be avoided. A deviation of the individual transducer elements from a reference position can be calibrated and entered in a calibration table, for example. In transducer units having transducer elements with the same focal length, the surface to be scanned of the sample can be divided, wherein the sample can be scanned line by line with each individual transducer element.

The acoustic microscope, for example, the ultrasonic scanning microscope, for carrying out the method comprises a positioning system, at least one transducer unit, such as, with several transducer elements, a pulse generator unit for the transducer unit, such as pulse generators having a number corresponding to the transducer elements, and a receiving unit, such as one receiving apparatus for each transducer element. In addition, the acoustic microscope can comprise a data processing system and a module for digitizing the received analog ultrasonic signals.

In the method, in the case of a transducer unit with several transducer elements, the lateral distances of the individual transducer elements can be taken into account on the basis of a (pre-) calibration, so that the surface to be examined and scanned of a sample can be scanned in an optimized manner. Thereby, in case of a continuous line by line, i.e., linear, scanning (in the X direction) with a predetermined and configurable number of image points per line, the distance from line to line in the Y direction can be freely selectable. The linear scans can be performed with the same small displacement increments in the Y direction until the maximum distance between the transducer elements of the same properties is reached and then the transducer unit can be moved in the Y direction by this distance with a larger displacement increment in the Y direction, so that a high-resolution image of the surfaces to be examined can be produced at increased analysis speed.

In the method, several linear scans of the sample (in the X direction) can be performed by the transducer unit, wherein the transducer unit can be displaced in each case by a small, for example, constant, displacement increment in the Y direction in each case after a linear scan of the sample, and, after a predetermined number n (n≥2, 3, . . . ) of several linear scans of the sample, the transducer unit can be displaced in the Y direction by a large, such as constant, displacement increment, which can be greater than the small displacement increment, and/or that, after a linear scan of the sample, the transducer unit can be displaced in the Y direction by a large, for example, constant, displacement increment, and, after the displacement of the transducer unit by the large displacement increment, several n (n≥2, 3, . . . ) linear scans of the sample are taking place by the transducer unit, wherein, after each of the several linear n (n≥2, 3, . . . ) scans of the sample, the transducer unit can be displaced in each case by a small, for example, constant, displacement increment in the Y direction, which can be smaller than the large displacement increment.

Thus, a high-resolution image of the surfaces to be examined of the sample can be obtained, in which, for example, the pixel size of the distance of the linear scans (in the Y direction) can be smaller than the distance of the individual transducer elements (in the Y direction) of a, for example, linear, array with transducer elements. For example, the ratio of pixel size distance of the linear scans to distance of the individual transducer elements (in the Y direction) can be less than 1:10, such as less than 1:100, or 1:1000.

In addition, in the method, the transducer unit can be moved in a meandering course in the X-Y plane relative to the sample. For this purpose, a corresponding positioning system can be provided in order to move the transducer unit relative to the sample to be examined.

According to a further exemplary embodiment, in the method,
a.) the sample can be scanned by using a transducer unit for a scanning acoustic microscope, for example, an ultrasonic scanning microscope, where several transducer elements can comprise one transducer and one lens, wherein at least two transducer elements can comprise different focal lengths, or
b.) the sample can be scanned by using a transducer unit with several transducer elements comprising one transducer and one, for example acoustic, lens, wherein the transducer elements can comprise the same focal length and/or the transducer elements arranged next to each other in a linear or rhombic arrangement in the Y direction.

Moreover, the transducer unit can comprise several transducer elements arranged in the Y direction, for example, one behind the other and/or linearly, wherein several linear m (m≥2, 3, 4, . . . ) scans can be performed in the X direction by the respective transducer elements, wherein the distances of the linear m (m≥2, 3, 4, . . . ) scans by the respective transducer elements can be equidistant in the Y direction and, after the performance of the linear m (m≥2, 3, 4, . . . ) scans by the transducer unit, the transducer unit can be displaced in the Y direction with the displacement increment, which can correspond to the product of the equidistant distance of the linear scans with the number of the linear m (m≥2, 3, 4, . . . ) scans and the number of the transducer elements of the transducer unit in the Y direction.

In the method, the image resolution to be attained can be independent of the distance and the arrangement of the individual transducer elements, e.g. of an array. In addition, the individual transducer elements can be freely adjustable and optimizable with regard to their resolution capacity and their signal intensity.

The image resolution attained by the method can be independent of the distance and the arrangement of the individual transducer elements of a transducer unit or a transducer array, wherein the individual transducer elements can be configurable with regard to their resolution capacity and their focal length depending on the requirement.

Due to a use of transducer elements of different focal lengths in a transducer unit, the surfaces or planes to be examined of a sample in one or more depth planes, which each are or will be determined by corresponding focal lengths of the individual transducer elements of the transducer unit of the transducer array, can be scanned according to the method in one embodiment. In addition, according to a further aspect, the lateral deviation of each individual transducer element can be calibrated and the scan field can be enlarged by the corresponding amount, wherein possible deviations can be corrected during the creation of the images in that gapless and congruent images are produced.

In a further exemplary embodiment, in the method, the transducer unit, for example, with several transducer elements, can comprise a length in the Y direction, wherein, after several linear scans in the X direction by the transducer unit, the transducer unit can be displaced in the Y direction with a displacement increment that corresponds to the length of the transducer unit, wherein the respective distances of the several linear scans performed prior to the displacement of the transducer unit in the Y direction with the displacement increment that corresponds to the length of the transducer unit can correspond to a natural fraction of the length of the transducer unit (length of the transducer unit/t, t≥2, 3, 4, . . . ).

Further, in the method, the transducer unit can comprise several transducer elements arranged in the Y direction, for example, next to each other and/or linearly, wherein the transducer elements can each comprise a, for example, constant, width in the Y direction, wherein several linear p (p≥2, 3, 4, . . . ) scans can be performed in the X direction, wherein the distances between the linear p (p≥2, 3, 4, . . . ) scans can correspond to a fraction of the width of the transducer elements (width of the transducer elements/p, p≥2, 3, 4, . . . ), and, after said performance of the linear p (p≥2, 3, 4, . . . ) scans, the transducer unit can be displaced in the Y direction by the displacement increment, which corresponds to a multiple of the width of the transducer elements.

In one configuration of the method, the large, displacement increment of the transducer unit in the Y direction can be corrected by a tolerance correction value after the performance of the several linear scans by the transducer unit, wherein the tolerance correction value can be formed such that the distance in the Y direction of the last linear scan prior to the displacement of the transducer unit by the large displacement increment to the first linear scan after the displacement of the transducer unit by the large displacement increment can correspond to the distance of the several linear scans prior to and/or after the displacement of the transducer unit by the large displacement increment in the Y direction, or wherein the tolerance correction value can be formed such that the distance between all linear scans by the transducer unit is constant.

The transducer unit can comprise several transducer elements, wherein the transducer elements can be operated in parallel. The pulse generators for each transducer element and/or the receiving apparatuses for each transducer element can be operated in parallel. Alternatively, in one configuration, a pulse operation can take place with a time offset of the total decay time for the transducer signals, wherein a crosstalk of the individual transducer elements can be minimized and/or the signals of a transducer element caused by sound waves do not interfere with adjacent transducer elements.

It is possible that for the performance of the method, a transducer unit can be provided with several transducer elements in a compact configuration with transducer elements separated from each other, or with a monolithic block for the transducer elements.

Furthermore, in the method, in one configuration, the distance between the transducer unit and the surface of the sample can be controlled by a transducer element. Alternatively, a distance control between the transducer unit and the sample can be feasible by a weighted value, for example by using a corresponding algorithm, of the various transducer elements.

For the performance of the method, a transducer unit for a scanning acoustic microscope, for example, an ultrasonic scanning microscope, with several transducer elements can comprise one transducer and one, for example, acoustic, lens, wherein at least two transducer elements can comprise different focal lengths.

In the case of a use of the transducer unit in a scanning acoustic microscope, several linear scans can take place simultaneously in one, for example single, scanning method, wherein the scans can take place simultaneously in different planes of the sample due to the different focal lengths of the transducer elements of the transducer unit. Thus, different scan fields of the sample to be examined can be obtained in different planes of the sample during a scan operation.

Apart from a transducer for generating a sound signal and an acoustic lens for focusing, the individual transducer elements can comprise a pulse generator, a transmitting/receiving switch, a receiver for receiving the sound signals reflected or transmitted by the sample, and an A/D converter for converting the received sound signals into digital values for displaying (gray scale) images. The ultrasonic signals reflected or transmitted by the sample can be measured and converted for generating the image. Additionally, the propagation times of the signals or their phase shifts can be gained as further image information. In a scanning method, the sample can be scanned pixel by pixel and line by line. Hereby, the transducer unit or the transducer elements can be moved relative to the sample to be examined.

For this purpose, in the transducer unit, for example, exclusively, two transducer elements with different focal lengths in relation to an X-Y plane can be arranged next to each other in a linear arrangement in the Y direction or one behind the other in the X direction, or that, for example, exclusively, two transducer elements with different focal lengths in relation to an X-Y plane can be arranged, for example diagonally, displaced to each other in the X direction and in the Y direction.

In addition, the transducer unit can comprise several transducer elements with a first focal length and several transducer elements with a second focal length, which can differ from the first focal length, in relation to an X-Y plane,
wherein an array of transducer elements arranged next to each other, for example, linearly, in the Y direction with the first focal length and an array of transducer elements arranged next to each other, for example, linearly, in the Y direction with the second focal length can be arranged one behind the other in the X direction,
or wherein an array of transducer elements arranged next to each other, for example, linearly, in the Y direction with the first focal length and an array of transducer elements arranged next to each other, for example, linearly, in the Y direction with the second focal length can be arranged, for example, diagonally, displaced to each other in the X direction and in the Y direction.
or wherein transducer elements with the first focal length and transducer elements with the second focal length can be arranged one behind the other, for example, linearly, in an alternating order in the Y direction.

The transducer unit can comprise, for example, more than two transducer elements with a first focal length and more than two transducer elements with a second focal length. Due to the, for example, parallel or simultaneous, use of several arrays with several transducer elements for an acoustic microscope, for example, with more than two transducer elements of a first focal length and with more than two transducer elements of a second focal length, the application possibilities of the acoustic microscope can be increased since several exposures of images can be obtained simultaneously in each case in different planes in an examination process of a sample by the transducer elements with the different focal lengths. Besides, due to the arrays, the time for an examination in the scanning method can be shortened, since several transducer elements of one focal length are scanning the sample across a larger width in the Y direction or a wider scan field.

Further, the object can be solved by a scanning acoustic microscope, for example, an ultrasonic scanning microscope, wherein the scanning acoustic microscope is formed with a transducer unit as described above, or the scanning acoustic microscope is configured to carry out the above-described method for operating an acoustic microscope. To avoid repetition, reference is made explicitly to the above explanations.

A method for operating a scanning acoustic microscope, for example, an ultrasonic scanning microscope, is also provided, wherein a sample is scanned in an X-Y plane by an above-described transducer unit, for example, with one or more transducer elements comprising one transducer and one lens, wherein the transducer unit can be moved in the X direction for a linear scanning of the sample, wherein, after a linear scanning of the sample by the transducer unit, the transducer unit can be displaced in the Y direction by a displacement increment, wherein, after the displacement of the transducer unit in the Y direction, at least one further linear scanning of the sample can be performed by the transducer unit in the Y direction.

In this case, in the scanning method, the sample to be examined can be displaced by the transducer unit with a constant displacement increment in the Y direction after each linear scanning in the X direction. For example, the transducer unit can comprise several transducer elements, wherein the transducer elements can be operated in parallel. According to another aspect, the transducer unit can be moved in a meandering course in the X-Y plane relative to the sample.

### BRIEF DESCRIPTION OF THE DRAWINGS

Further features will become apparent from the description of the embodiments together with the claims and the attached drawings. Embodiments may fulfill individual features or a combination of several features.

The embodiments are described below without restricting the general inventive idea on the basis of exemplary embodiments with reference to the drawings, and regarding any details which are not explained further in the text reference is expressly made to the drawings. In the drawings:

FIGS. 1a, 1b, in each case, schematically illustrate perspective cross-sectional views of transducer units for an acoustic microscope;

FIGS. 2a, 2b, in each case, schematically illustrate perspective cross-sectional views of further transducer units for an acoustic microscope;

FIG. 3 schematically illustrates a single scan field of a transducer unit of an acoustic microscope for examining a sample;

FIG. 4 schematically illustrates an entire scan field of a transducer unit of an acoustic microscope for examining a sample;

FIG. 5 illustrates a schematic representation of a meandering scan course of a transducer unit across a sample surface in detail, and

FIG. 6 schematically illustrates the scan fields of a further transducer unit.

In the drawings, the same or similar types of elements and/or parts are provided with the same reference numbers so that a corresponding re-introduction is omitted.

### DETAILED DESCRIPTION

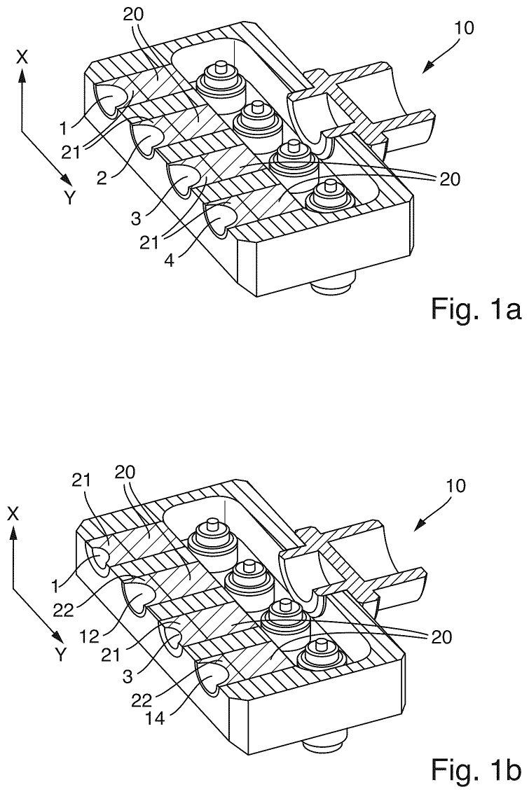

FIG. 1a and FIG. 1b illustrate, in each case, schematic perspective views in cross section of transducer units 10 for an acoustic microscope, for example an ultrasonic scanning microscope.

The transducer unit 10 in FIG. 1a comprises, in the Y direction, i.e. perpendicular to the scanning direction of the transducer unit 10 in the X direction, transducer elements (transducers) 1, 2, 3, 4 arranged in a linear arrangement next to each other, all of which comprising the same focal length. The transducer elements 1, 2, 3, 4 are identical in construction and comprise one transducer 20 and one acoustic lens 21 arranged on the transducer 20 for focusing the ultrasonic signals onto a sample to be examined.

In the exemplary embodiment in FIG. 1b, the transducer unit 10 comprises transducer elements 1, 12, 3 and 14 in a linear arrangement in the Y direction in an alternating order. The transducer elements 1 and 3 have a (first) focal length and the transducer elements 12 and 14 have a (second) focal length, wherein the focal length of the transducer elements 1 and 3 and the focal length of the transducer elements 12 and 14 are different. The transducer elements 12 and 14 have here a lens 22, the focal length of which is different from the focal length of the lens 21 for the transducer elements 1 and 3.

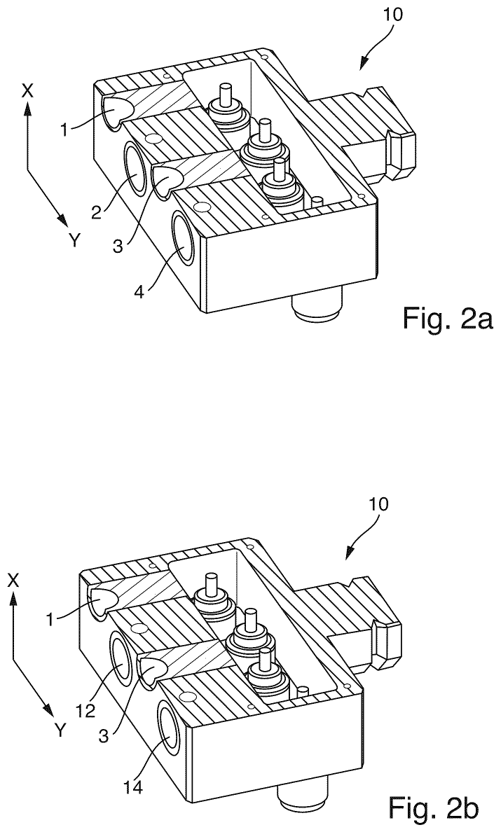

In FIG. 2a and FIG. 2b illustrate in each case schematic perspective views in cross section of transducer units 10 for an acoustic microscope, for example, an ultrasonic scanning microscope.

The configurations of the further transducer units 10 according to FIG. 2a and FIG. 2b differ from the configurations of the transducer units 10 according to FIG. 1a and FIG. 1b in the arrangement of the transducer elements.

In the configuration of the transducer unit 10 according to FIG. 2a, the transducer elements 1 and 3 are displaced in the X direction to the transducer elements 2 and 4 compared to the transducer unit 10 in FIG. 1a. The transducer elements 1, 2, 3, and 4 comprise the same focal length.

In the configuration of the transducer unit 10 according to FIG. 2b, the transducer elements 1 and 3 are displaced in the X direction to the transducer elements 12 and 14 compared to the transducer unit 10 in FIG. 1b. Transducer elements 1 and 3 comprise the same focal length that differs from the focal length of the transducer elements 12 and 14.

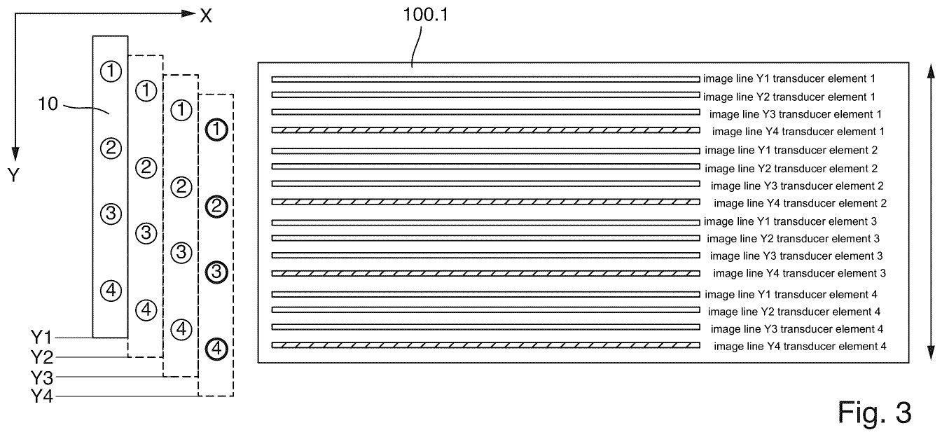

In FIG. 3 schematically shows a single first scan field 100.1 of the transducer unit 10 according to the configuration of FIG. 1a with transducer elements 1, 2, 3, 4 comprising the same focal length for a sample to be examined. By the transducer elements 1, 2, 3, 4 in the Y position Y1, the image lines Y1 transducer element 1, Y1 transducer element 2, Y1 transducer element 3, Y1 transducer element 4 are obtained simultaneously in a linear scanning of the sample as a display, e.g. on a monitor, corresponding to the received reflected signals for the transducer elements 1, 2, 3, 4 from the sample in a scanning in the X direction.

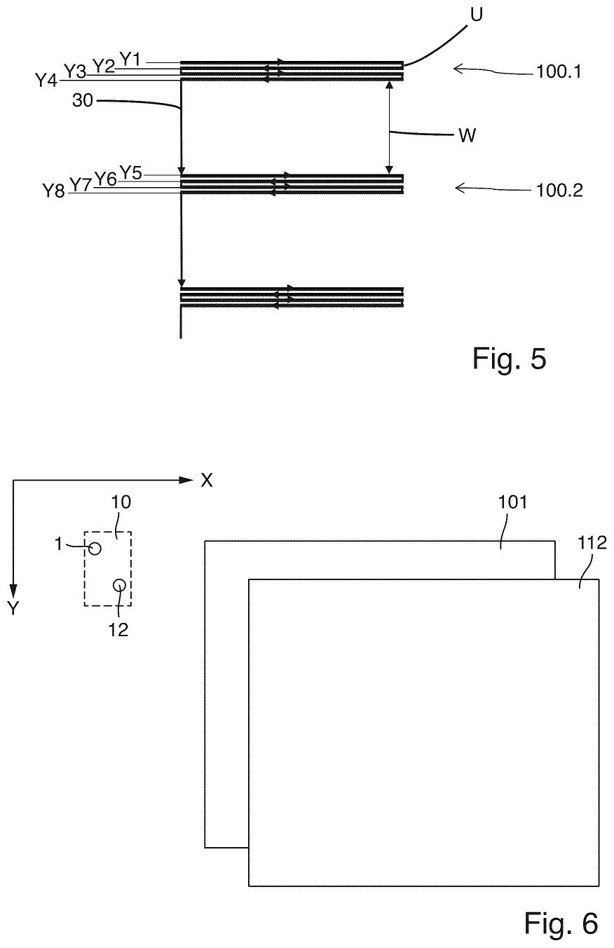

Subsequently, in an end position, the transducer unit 10 is moved from the Y position Y1 to the Y position Y2 by a small displacement increment U in the Y direction (see FIG. 5), so that the image lines Y2 transducer element 1, Y2 transducer element 2, Y2 transducer element 3, Y2 transducer element 4 are obtained from the sample in a linear scanning of the sample. Thereafter, the transducer unit 10 is moved from the Y position Y2 to the Y position Y3 by a small displacement increment U (see FIG. 5), wherein the image lines Y3 transducer element 1, Y3 transducer element 2, Y3 transducer element 3, Y3 transducer element 4 are subsequently obtained by the transducer elements 1, 2, 3, 4. In an analogous manner, the transducer unit 10 is moved further from the Y position Y3 to the Y position Y4 by a small displacement increment U in the Y direction (see FIG. 5) in order to obtain the image lines Y4 transducer element 1, Y4 transducer element 2, Y4 transducer element 3, Y4 transducer element 4 simultaneously in a linear scanning in the X direction, thereafter.

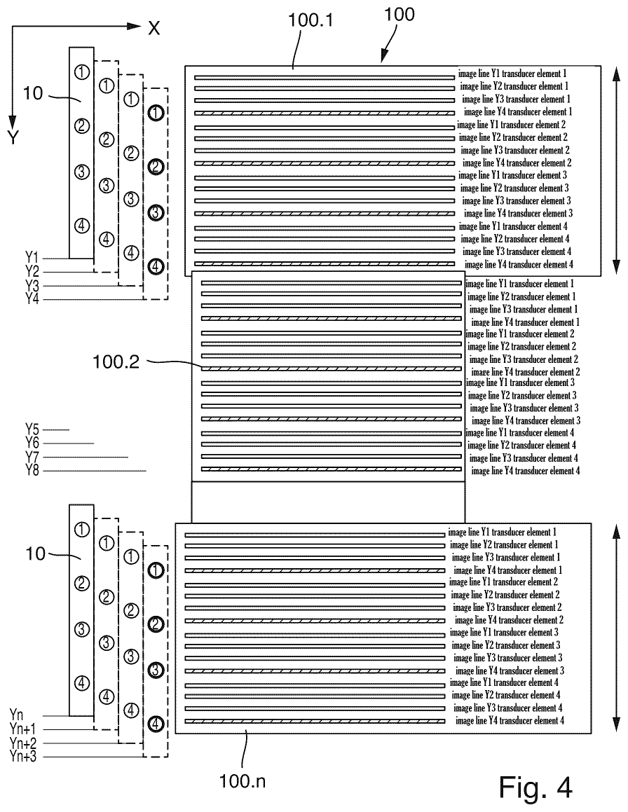

In FIG. 4 schematically shows an entire scan field 100 of the transducer unit 10 of an acoustic microscope for examination of a sample. After the acquisition of the entire scan field 100.1 with four linear scans in the X direction, as shown with the help of FIG. 3, the transducer unit 10 is displaced in the Y direction by a displacement increment W (see FIG. 5) that is greater than the displacement increment U (see FIG. 5) between the Y positions Y1, Y2, Y3, Y4. For example, the displacement increment W of the transducer unit 10 in the Y direction corresponds to the length that results from the product of the equidistant distance U of the linear scans with the number of linear m (in the present case m=4) scans and the number of (in the present exemplary case: four) transducer elements of the transducer unit 10 in the Y direction.

In another configuration, the Y distances of the linear four scans in the positions Y1, Y2, Y3 and Y4 correspond to a fraction of the width of the transducer elements 1, 2, 3, 4, wherein after the performance of the linear four scans in the X direction, the transducer unit is displaced in the Y direction with the displacement increment, which corresponds to a multiple of the width of the transducer elements.

After the acquiring and the complete display of the scan field 100.1, as described in FIG. 3, and after a displacement in the Y direction by a large displacement increment W (see FIG. 5), the transducer unit 10 is moved from the Y position Y4 to the Y position Y5 for the acquisition of a subsequent scan field 100.2, wherein the transducer unit 10 is subsequently moved in a meandering manner from the Y position Y5 to the further Y positions Y6, Y7 and Y8 in the scanning method for the acquisition of a scan field 100.2 in order to generate the respective image lines for the four Y positions Y5, Y6, Y7 and Y8 by the transducer elements 1, 2, 3, 4 by linear scanning of the sample. These method steps between the individual Y positions of the transducer unit 10 and between two successive scan fields are repeated several times in a corresponding manner until the last scan field 100.n for the Y positions Yn, Yn+1, Yn+2, Yn+3 is scanned by the transducer elements 1, 2, 3, 4 and the corresponding image lines are generated.

It is possible to use, instead of the transducer unit 10 from FIG. 1a, a transducer unit 10 according to the schematic configurations of FIG. 1b or FIG. 2a or FIG. 2b or another transducer unit with several transducer elements, which are arranged in a predetermined arrangement in the X direction and/or in the Y direction, and/or comprise different focal lengths, for the acquisition of an entire scan field 100, wherein the transducer units 10 are moved according to an, for example, meandering, scanning method with different displacement increments in the Y direction during the scanning method.

FIG. 5 shows in detail a schematic representation of the scan course of the transducer unit 10 (see FIG. 4) with the four transducer elements 1, 2, 3, 4 across a section of a sample surface of the sample. For the acquisition of the scan fields 100.1 and 100.2, the transducer unit 10 is moved between the several Y positions Y1, Y2, Y3, Y4 and Y5, Y6, Y7, Y8 of the scan field 100.1 and 100.2, respectively, by the (small) displacement increment U in each case in the Y direction and, after acquisition of a scan field 100.1 or 100.2, by the displacement increment W, which is greater than the displacement increment U.

The movement of the transducer unit 10 takes place in the form of a meander 30, whereby the sample is scanned in a meandering manner. Thereby, the Y increment of the meander 30 for the transducer unit 10 is varied with the displacement increments U and W in the Y direction for the acquisition of the entire scan field 100.

In the exemplary embodiment of FIG. 6, a transducer unit 10 with two transducer elements 1 and 12 as well as the entire scan fields 101 and 112 for the two transducer elements 1 and 12 are shown schematically. Transducer elements 1 and 12 comprise different focal lengths in this configuration.

As can be seen from FIG. 6, the transducer elements 1 and 12 are arranged diagonally displaced in the X direction and in the Y direction on the transducer unit 10, thereby, in the case of scanning a sample, the entire scan field 101 for the transducer element 1 and the entire scan field 112 for the transducer element 12 are also formed correspondingly with an offset in the X direction and in the Y direction. Accordingly, the generated entire scan images 101, 102, which are obtained with the transducer elements 1 and 12, are displayed with an offset. In one configuration, the transducer unit 10 is moved in a meandering manner across the sample for a linear scanning by the transducer elements 1 and 12, wherein the Y increment is constant between two linear scans.

In a further configuration (not represented here), instead of the transducer unit 10 represented in FIG. 6, for example, the transducer unit 10 represented in FIG. 2b is used for the acquisition of the entire scan fields 101 and 112, wherein the transducer unit 10 is moved in each case according to a, for example, meandering, scanning method with different displacement increments in the Y direction. Also, other configurations of the scanning method are feasible by using transducer units with several transducer elements, which comprise different focal lengths, wherein the transducer units are moved according to, for example, meandering, scanning methods with different displacement increments in the Y direction during the acquisition of an entire scan field.

While there has been shown and described what is considered to be preferred embodiments, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

1,2,3,4 transducer element
   10 transducer unit
12, 14 transducer element
   20 transducer
21, 22 lens
   30 meander
   100 entire scan field
   101 entire scan field
100.1, 100.2 . . . 100.n scan field
   112 entire scan field
   U displacement increment
   W displacement increment

What is claimed is:

1. A method for operating a scanning acoustic microscope, the method comprising:
scanning a sample in an X-Y plane by a transducer unit having one or more transducers;
wherein the scanning comprises:
moving the transducer unit in the X direction for a linear scanning of the sample;
after the linear scanning of the sample by the transducer unit, displacing the transducer unit in the Y direction by a displacement increment; and
varying a size of the displacement increment of the transducer unit in the Y direction for the scanning of the sample.

2. The method according to claim 1, further comprising, after the displacement of the transducer unit in the Y direction, performing at least one further linear scanning of the sample by the transducer unit in the Y direction.

3. The method according to claim 1, wherein each of the one or more transducers comprising a lens.

4. The method according to claim 1, further comprising performing several linear scans of the sample by the transducer unit;
displacing the transducer unit is displaced in each of the several linear scans of the sample by a first displacement increment in the Y direction, and
one or more of:
after a predetermined number of the several linear scans of the sample, displacing the transducer unit in the Y direction by a second displacement increment greater than the first displacement increment; and
after a linear scan of the sample, displacing the transducer unit in the Y direction by a third displacement increment; and, after the displacement of the transducer unit by the third displacement increment, making several linear scans of the sample by the transducer unit, wherein, after each of the several linear scans of the sample, displacing the transducer unit in each of the several linear scans by a fourth displacement increment in the Y direction smaller than the third displacement increment.

5. The method according to claim 1, wherein one or more of the first, second, third and fourth displacement increments are constant over the several linear scans of the sample.

6. The method according to claim 1, wherein the moving of the transducer unit comprises moving the transducer unit (10) in a meandering course in the X-Y plane relative to the sample.

7. The method according to claim 1, wherein one of:
the transducer unit comprises several transducers each comprising a lens, wherein at least two transducers of the several transducers comprise different focal lengths, or
the transducer unit comprises several transducers each comprising a lens, wherein the several transducers comprise one or more of a same focal length and are arranged next to each other in a linear or rhombic arrangement in the Y direction.

8. The method according to claim 1, wherein
the transducer unit comprises several transducers arranged in the Y direction, one of, one behind the other and linearly,
the method comprises performing several linear scans in the X direction by the several transducers,
the distances of the linear scans by the transducers are equidistant in the Y direction and, after the performance of the several linear scans by the transducer unit, displacing the transducer unit in the Y direction with the displacement increment, which corresponds to the product of the equidistant distance of the linear scans with the number of the linear scans and the number of the transducers of the transducer unit in the Y direction.

9. The method according to claim 1, wherein the transducer unit with several transducers comprises a length in the Y direction, wherein, after several linear scans in the X direction by the transducer unit, displacing the transducer unit in the Y direction with a displacement increment that corresponds to the length of the transducer unit, wherein the respective distances of several linear scans performed prior to the displacement of the transducer unit in the Y direction with the displacement increment that corresponds to the length of the transducer unit correspond to a natural fraction of the length of the transducer unit.

10. The method according to claim 1, wherein the transducer unit comprises several transducer elements arranged in the Y direction, one of next to each other and linearly, wherein the transducers each comprise a width in the Y direction, performing several linear scans in the X direction, wherein distances between the several linear scans correspond to a fraction of the width of the transducers, and, after performance of the several linear scans, displacing the transducer unit in the Y direction by the displacement increment, which corresponds to a multiple of the width of the transducer elements.

11. The method according to claim 10, wherein the width in the Y direction is constant.

12. The method according to claim 8, wherein
a first displacement increment of the transducer unit in the Y direction is corrected by a tolerance correction value after performance of the several linear scans by the transducer unit; and
one of:
the tolerance correction value is formed such that the distance in the Y direction of the last linear scan prior to the displacement of the transducer unit by the first displacement increment to the first linear scan after displacement of the transducer unit by the first displacement increment corresponds to a distance of the several linear scans one or more of prior to and after the displacement of the transducer unit by the first displacement increment in the Y direction, or
the tolerance correction value is formed such that the distance between all of the several linear scans by the transducer unit is constant.

13. The method according to claim 1, wherein the transducer unit comprises several transducers and the method further comprises operating the transducers in parallel.

14. The method according to claim 7, wherein one of:
two transducers with different focal lengths in relation to an X-Y plane are arranged one of next to each other in a linear arrangement in the Y direction or one behind the other in the X direction, or
two transducers with different focal lengths in relation to an X-Y plane are arranged displaced to each other in the X direction and in the Y direction.

15. The method according to claim 14, wherein the two transducers with different focal lengths in relation to an X-Y plane are arranged displaced diagonally relative to each other in the X direction and in the Y direction.

16. The method according to claim 7, wherein
the transducer unit comprises several transducers with a first focal length and several transducers with a second focal length, which differs from the first focal length in relation to an X-Y plane, and
one of:
an array of the several transducers elements arranged next to each other in the Y direction with the first focal length and an array of the several transducers arranged next to each other in the Y direction with the second focal length are arranged one behind the other in the X direction,
an array of the several transducers arranged next to each other in the Y direction with the first focal length and an array of the several transducers arranged next to each other in the Y direction with the second focal length are arranged displaced relative to each other in the X direction and in the Y direction; or
the several transducers with the first focal length and the several transducers with the second focal length are arranged one behind the other in an alternating order in the Y direction.

17. The method according to claim 7, wherein the several transducers with the first focal length and the transducers with the second focal length are one of arranged linearly in the Y direction or diagonally relative to each other in the X direction and in the Y direction.
